(19) United States
(12) Patent Application Publication
(10) Pub. No.: US 2012/0317021 A1
(43) Pub. Date: Dec. 13, 2012

(54) METHOD AND SYSTEM FOR FINANCING RESEARCH AND DEVELOPMENT RELATED ACTIVITY BY THE GENERAL PUBLIC

(76) Inventor: Daisy L.W. Cheung, Kowloon (HK)

(21) Appl. No.: 13/590,617

(22) Filed: Aug. 21, 2012

Related U.S. Application Data
(63) Continuation-in-part of application No. 12/634,163, filed on Dec. 9, 2009.

(51) Int. Cl. G06Q 40/00

(52) U.S. Cl. 705/39

(57) ABSTRACT

A computer-based method for financing an R&D project, including: storing, in a memory element for a computer, computer readable instructions; and executing, using a processor for the computer, the instructions to transmit, for display: a list of R&D projects and estimated funding requirements; a request for funding of an R&D project from the list; and, an offer to provide a portion, proportional to a monetary contribution for the project, of proceeds generated by the project as funding for another R&D project to be selected by a donor providing the monetary contribution. The method receives: the contribution and a selection of the other project from the list. The method determines the proceeds generated by the project, determines the portion of the proceeds, and directs a transfer of funds equal to the portion of the proceeds as funding for the other R&D project.

### TECHNICAL FIELD

The present disclosure relates generally to a computer based method and system to enable financing of research and development (R&D) related activity by the general public, in particular, using a fee payment to an entity to implement or finance the activity and using residual funds, based on the implementation or financing costs and operating costs, to finance the same or another R&D related activity.

### BACKGROUND

People are very well informed of what is going on around them. As they get more knowledgeable, they want to have a bigger say in how their societies are being run and how problems are being solved. For many reasons, people are getting less and less reliant on authorities, governments, politicians, corporations, and established institutions. Well informed people are more motivated to examine problems in greater depth and identify all options available. In doing so, they are in a position to: cross checking if governmental, corporate actors are doing the “right” thing; lobby for policy changes; and protect themselves from adversities caused by natural disasters or government/institution/corporate incompetence.

Conducting research and development (R&D) is a scientific way of assessing problems today and improving our future tomorrow. However, scientific and academic R&D conducted by universities and public institutions is mostly funded by governments, institutions, corporations or charity foundations. The research direction is mostly steered by peer reviews or the established institutions. Therefore, projects that do not fall in the main stream or do not align with the institutional thinking are less likely to be funded by the established institutions or governments.

The major source of government funding is tax payers' money; however, the average individual, “the person on the street,” have little say in setting agendas for R&D activity that takes place in their own country and have no free access to research reports that they have contributed funding to. Basically a small group decides what is important for everyone.

There are charity foundations that help to raise funds from the public for supporting research, such as American Institute for Cancer Research etc.; however, the regular donors play no part in deciding what projects to fund. There is not yet an established mechanism for average individuals to tell scientists and researchers directly what the individuals want to know.

There are many individuals who want to make a change and are willing to fund research projects of their choice. Peer review currently decides the allocation of more than 95% of the world's research funding. With experienced researchers winning the bulk of the funding pot, such system puts younger, newer or not-so-well connected academics at a disadvantage, and perhaps society as well.

For scientists and researchers, major funding sources are from the government, industry or foundation. Lacking research funding is one of the key factors hindering their academic advancement as well as the progress of humanity in, but not limited to, the social, economic, political and physical aspects of life. The world is getting more and more complicated. Research dictated by the established institutions can stifle the search for alternative solutions, for example, if the alternative solutions are contrary to the interests of the institutions. More diverse R&D activity is needed regarding various socio-economic, political, and environmental and health challenges facing the world.

An article on “http://www.huffingtonpost.com/2012/08/14/science-exchange-reproducibility-initiative_n_{—}1775013.html” (the Huffington Post) entitled “Science Exchange ‘Reproducibility Initiative’ Tests Results Of Published Research Findings Reuters” |Posted: Aug. 14, 2012 7:59 am Updated: Aug. 14, 2012 12:28 pm by Sharon Begley discusses the problem of scientific studies making incorrect claims. To support her assertion, Begley notes the prevalence of scientific studies that cannot be duplicated (are incorrect). For example, Bayer Healthcare reported that its scientist could not reproduce 75% of published findings in cardiovascular disease, cancer, and women's health.

At present, an average donor to an R&D project entity does not have the ability to direct how their financial contribution, for example, funds provided by the average donor to fund an R&D project entity, are to be used. For example, if the entity produces a range of products or services, the average donor cannot direct how some or all of their direct or indirect contribution will be used with respect to the range of products or services. For example, the average donor cannot direct their contribution to a specific product or service. Nor can the average donor direct their contribution toward ancillary activities related to the entity. In particular, the average donor cannot direct or select R&D funded by their contribution.

### SUMMARY

According to aspects illustrated herein, there is provided a computer-based method for financing a research and development (R&D) related activity, including: storing, in at least one memory element of at least one computer, computer readable instructions; and executing, using at least one processor for the at least one computer, the computer readable instructions to transmit, for display on a publicly accessible network: a first list including a first plurality of R&D related projects or activities and respective descriptions and estimated funding requirements for each R&D related project or activity on the first list; a request for funding of a first R&D related project or activity from the first plurality of R&D related projects or activities; and, an offer to provide a portion, proportional to a monetary contribution provided for the first R&D related project or activity, of proceeds generated by the first R&D related project or activity as funding for a second R&D related project or activity to be selected by a donor providing the monetary contribution for the first R&D related project or activity. The method: receives, from the donor: the monetary contribution and a selection of the second R&D related project or activity from the first plurality of R&D related projects or activities. The method: determines the proceeds generated by the first R&D related project or activity; determines the portion of the proceeds; and directs a transfer of funds equal to the portion of the proceeds as funding for the second R&D related project or activity.

According to aspects illustrated herein, there is provided a computer-based system for financing a research and development (R&D) related activity, comprising at least one memory element of at least one computer configured to store computer readable instructions; and at least one processor for the at least one computer configured to execute the computer readable instructions to transmit, for display on a publicly accessible network: a first list including a first plurality of R&D related projects or activities and respective descriptions and estimated funding requirements for each R&D related project or activity on the first list; a request for funding of a first R&D related project or activity from the first plurality of R&D related projects or activities; and an offer to provide a portion, proportional to a monetary contribution provided for the first R&D related project or activity, of proceeds generated by the first R&D related project or activity as funding for a second R&D related project or activity to be selected by a donor providing the monetary contribution for the first R&D related project or activity. The processor is configured to execute the computer readable instructions to receive, from the donor: the monetary contribution for the first R&D related project or activity and a selection of the second R&D related project or activity from the first plurality of R&D related projects or activities. The processor is configured to execute the computer readable instructions to: determine the proceeds generated by the first R&D related project or activity; determine the portion of the proceeds; and direct a transfer of funds equal to the portion of the proceeds as funding for the second R&D related project or activity.

According to aspects illustrated herein, there is provided a computer-based system for financing a research and development (R&D) related activity, comprising storing, in at least one memory element of at least one computer, computer readable instructions; and executing, using at least one processor for the at least one computer, the computer readable instructions to transmit, for display on a publicly accessible network: a first list including a first plurality of R&D related projects or activities and respective descriptions and estimated funding requirements for each R&D related project or activity on the first list; a request for funding of a first R&D related project or activity from the first plurality of R&D related projects or activities; and an offer to provide a portion, proportional to a monetary contribution provided for the first R&D related project or activity, of proceeds generated by the first R&D related project or activity as funding for a second R&D related project or activity to be selected by a donor providing the monetary contribution for the first R&D related project or activity. The method executes, using the at least one processor, the computer readable instructions to: accept respective donor registration information regarding a plurality of potential donors, the respective donor registration information including respective interests for potential donors in the plurality of potential donors; determine a respective correlation of each R&D related project or activity on the first list with the respective interests; and for each R&D related project or activity on the first list with a correlation greater than a specified degree of correlation with a respective interest, transmit a respective notification regarding said each R&D related project to a potential donor having the respective interest. The method executes, using the at least one processor, the computer readable instructions to receive, from the donor: the monetary contribution for the first R&D related project or activity and a selection of the second R&D related project or activity from the first plurality of R&D related projects or activities. The method executes, using the at least one processor, the computer readable instructions to: determine the proceeds generated by the first R&D related project or activity; determine the portion of the proceeds; and direct a transfer of funds equal to the portion of the proceeds as funding for the second R&D related project or activity.

### BRIEF DESCRIPTION OF THE DRAWINGS

The nature and mode of operation of the present invention will now be more fully described in the following detailed description of the invention taken with the accompanying drawing Figures in which:

FIG. 1 is a schematic block diagram of a computer-based system for financing a research and development (R&D) related activity or project;

FIG. 2 is a flow chart illustrating project selection for a computer-based system for financing a research and development (R&D) related activity or project; and,

FIGS. 3A and 3B are a flow chart illustrating project reporting for a computer-based system for financing a research and development (R&D) related activity or project.

### DETAILED DESCRIPTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be understood that any methods, devices or materials similar or equivalent to those described herein can be used in the practice or testing of the invention.

By research and development (R&D) we mean a term covering at least three activities: basic research, applied research, and experimental development. R&D includes creative work undertaken on a systematic basis in order to increase the stock of knowledge, including knowledge of man, culture and society, and the use of this stock of knowledge to devise new applications.

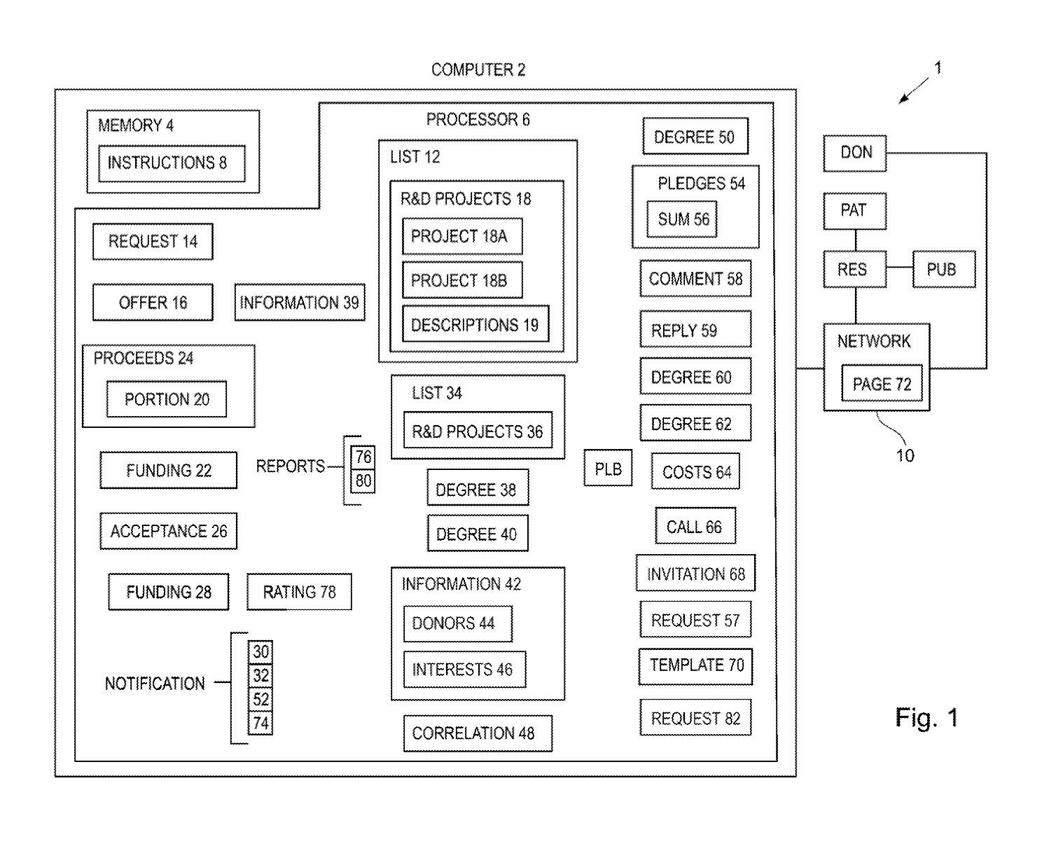

FIG. 1 is a schematic block diagram of computer-based system 1 for financing a research and development (R&D) related activity or project. System 1 includes at least one computer 2 with at least one memory element 4 and at least one processor 6. The memory element is configured to store computer readable instructions 8. The processor is configured to execute the computer readable instructions to transmit, for display on a publicly accessible network 10, list 12, request 14, and offer 16. List 12 includes a plurality of R&D related projects or activities 18 with respective descriptions and estimated funding requirements 19 for each R&D related project or activity on the list. In an example embodiment, request 14 is a pledge request, not a request for an actual contribution. For the sake of brevity, hereinafter, the term “R&D project” is used in place of “R&D related project or activity.” The request is a request for funding of an R&D project 18A from the plurality of R&D projects 18. The offer is to provide portion 20 of proceeds 24 generated by R&D project 18A as funding for R&D project 18B, from list 18, to be selected by donor DON. Portion 20 is proportional to a monetary contribution, or funding, 22 provided for R&D project 18A by donor DON.

The processor is configured to execute the computer readable instructions to receive, from the donor: monetary contribution 22 for R&D project 18A; a selection of R&D project 18B from the plurality of R&D projects 18; and acceptance 26 of the offer. The processor is configured to execute the computer readable instructions to determine proceeds 24 generated by R&D project 18A, determine portion 20 of the proceeds, and direct a transfer of funds equal to portion 20 of the proceeds as funding 28 for R&D project 18B.

In an example embodiment, each and every R&D project 18 on list 12 must be submitted by at least one respective university faculty member or public sector researcher RES. By public sector researcher, for example, we mean a researcher working for or with a publicly financed research entity, such as an institute, laboratory etc. The R&D project 18 is for respective research and development to be conducted by RES. That is, R&D projects eligible for inclusion on list 12 must be from an academic or publicly funded researcher. In an example embodiment, the processor is configured to execute the computer readable instructions to determine that the university faculty member or researcher has authored publication PUB regarding R&D project 18A and transmit notification 30 to the donor regarding the publication.

In an example embodiment, the processor is configured to execute the computer readable instructions to determine if patent application PAT, based on R&D project 18A has been filed, and transmit notification 32 to the donor regarding the patent application. Thus, system 1 automatically keeps funders of R&D project 18A appraised of progress of the project or ancillary activity associated with the project.

In an example embodiment, the processor is configured to execute the computer readable instructions to receive list 34 including a plurality of R&D projects 36. Projects 36 also must be submitted by at least one respective university faculty member or researcher at a public research entity. The processor determines a respective degree of novelty 38 for each R&D project 36 with respect to information 39 publicly available at the time at which list 34 is received. In an example embodiment, those R&D projects 36 with a determined degree of novelty greater than specified, or predetermined, degree of novelty 40 are included on list 12. The processor transmits for display on the publicly accessible network, the respective degree of novelty 38 for each R&D project 36. Thus, system 1 enables would-be donors to assess the degree of novelty of a proposed R&D project, which assists would-be donors in identifying proposed R&D projects most worthy of support.

In an example embodiment, the processor is configured to execute the computer readable instructions to accept respective donor registration information 42 regarding a plurality of potential donors 44, the respective donor registration information including respective interests 46 for potential donors in the plurality of potential donors. The processor determines a respective correlation 48 of each R&D project 18 with the respective interests. For each R&D project 18 with a correlation greater than a specified, or predetermined, degree of correlation 50 with a respective interest, the processor transmits a respective notification 52 regarding the R&D project 18 to a potential donor having the respective interest. Thus, system 1 automatically pairs interests of potential donors with proposed R&D projects.

In an example embodiment, the processor is configured to execute the computer readable instructions to accept respective pledges 54 for funding R&D project 18A from one or more potential donors 44, and transmit for display on the publicly accessible network, cumulative sum 56 of the respective pledges as a preliminary step to implementing the actual funding process. When sum 56 reaches request 14 for R&D project 18A, the processor transmits request for contribution 57. Thus, potential donors can indicate support for an R&D project without having funds tied up in an R&D project that never reaches the necessary funding level.

In an example embodiment, the processor is configured to execute the computer readable instructions to receive comment or suggestion 58 from a potential donor regarding R&D project 18A prior to receiving pledges 54, digitally notarize the comment or suggestion to establish a time at which the comment or suggestion is received, and store, in the memory element, the digitally notarized comment or suggestion. Thus, system 1 automatically stores an authenticated record of possible ideas or modifications that may be incorporated in R&D project 18A. The system enables an interactive exchange between potential donors and faculty members or researchers RES. For example, RES can respond to suggestion 58 with reply 59, the potential donor can respond with another comment 58 etc. prior to the potential donor making pledge 54.

In an example embodiment, the processor is configured to execute the computer readable instructions to determine degree of novelty 60 of R&D project 18A, updated to incorporate comment or suggestion 58, with respect to information 39 and when the degree of novelty is greater than specified, or predetermined, degree of novelty 62, transmit, for display on a publicly accessible network, description 19 of R&D project 18A updated to incorporate comment or suggestion 58 and degree of novelty 60. Thus, system 1 automatically updates the assessment of R&D project 18A on the network so that potential donors remain appraised of the possible viability of R&D project 18A. For example, the updated R&D project 18A may be of interest to a potential donor who was not previously interested in R&D project 18A or did not think that R&D project 18A was sufficiently novel.

R&D project 18 can be any project, service or function known in the art related to discovering and creating new knowledge in fields including, but not limited to, scientific, technological, humanities, politics, social, or environmental preservation, enhancement, or recovery. The system posts a set of guidelines regarding the projects eligible for inclusion in system 1. The guidelines can include legal, moral or ethical considerations.

Computer 2 and processor 6 can be any computer or processor, respectively, known in the art. Network 10 can be any publicly accessible network known in the art, for example, the Internet. System 1 invests or transfers portion 20, using any contribution direct or indirect, financial transfer, or financial instrument means known in the art. In one embodiment, a proportion of operating costs 64 associated with R&D project 18A or 18B are deducted from funding 22 or 28, respectively, prior to investing or transferring portion 20. Portion 20 and proceeds 24 are determined using any means known in the art, for example, using any standard accounting means known in the art. Any time period known in the art can be used as the time period in which to determine the proceeds.

In one embodiment, R&D project 18A is a one off project, that is, only one round of funding is anticipated. In an example embodiment, the entity/donor is offered an opportunity for longer term participation. For example, offer 16 includes the opportunity for annual or periodic financial support of an R&D project.

In one embodiment, R&D projects 18A and 18B are the same. Thus, system 1 enables a ‘roll over’ of proceeds into the same R&D project.

The following provides further detail regarding system 100. In an example embodiment, there are three types of users of system 100: regular site visitors; academic or public sector researchers seeking project contributions; and donors who have contributed to research projects.

In an example embodiment, academic or public sector personnel wishing to obtain funding must complete a one-time online registration as a researcher on the website. The personnel are required to prepare a profile page detailing their biography, research interests, and publications. The personnel also need to fill out an online form, not accessible to the public, detailing the administration details for project fund disbursement. The system generates a profile page for the researcher, including a link to the researcher's web page for the academic institution with which the research is associated, which helps verify the researcher's identify. Once registered, the researcher is given a password that allows the researcher to upload their project proposals to the site for seeking contributions from potential donors. The project proposals include digital copy of the text proposals and, if applicable, video that allow the researcher to present his/her proposal in more graphical terms. The system will authenticate the credentials of project applicants.

In an example embodiment, site users who want to become potential donors register with their user name and their email address and can specify their interests, such as interests 46. The site users are notified whenever there are projects proposals being submitted or project reports being released that correspond to their interest areas.

In an example embodiment, donors provide their payment details/method and contact information. Donors are given a password that allows them to log onto the pages that provide a full details of the progress of projects that they have supported.

In an example embodiment, the calls for research project proposal are continuous and ongoing. The system provides project proposal template 70 for registered researchers to prepare their project proposals. In an example embodiment, the R&D project applicant is required to perform a search of publicly available documents, for example information 39, in respective databases for patent applications, issued patents, published literature in the field of interest, published prior art database, and universities to establish the degree of novelty of the proposed R&D project, for example, degree of novelty 38 with respect to predetermined degree of novelty 40. After the search, the project applicant posts the degree of novelty as part of the information revealed in the project proposal. Completed proposals in a standardized format are uploaded to the site for the site visitors to review after being qualified by the entity for their eligibility.

In an example embodiment, proposed R&D projects are vetted as follows. The system verifies the credentials of a researcher for an uploaded proposed R&D project. If the system cannot verify the applicants, the system rejects the proposal. If the credentials are verified, the system performs a search of publicly available documents, for example information 39, in respective databases for patent applications, issued patents, published literature in the field of interest, published prior art database, and universities to establish, or verify if the faculty member or researcher RES has performed a novelty analysis, the degree of novelty of the proposed R&D project, for example, degree of novelty 38 with respect to predetermined degree of novelty 40. After the search, the system posts the degree of novelty on the network and uploads the R&D project proposal to the website. All site visitors, other than unregistered visitors, can log onto the system to review and comment on R&D projects, such as R&D projects 36. Site visitors can post their comments, such as comments 58 on comment page 72 on the network. Site visitors can start a comment page on any issue associated with a proposal. In general, there is only one comment page on one particular issue.

Comments can include challenges to the R&D project's novelty, technical content, or suggestions for improvement. The R&D project applicant can respond to the comments as he/she sees fit. Through these exchanges, the R&D project proposal is scrutinized by site visitors who may have very diverse, helpful, and applicable backgrounds, including experts in the field associated with the R&D project. Also, reviewers could review the proposals from new and different perspectives. The discussions on the comment pages also can shed light on the merits of the R&D project and help site visitors to decide if the R&D project is worth funding. All the comments are dated and the persons making the comments are authenticated, enabling spurious, fraudulent, or malicious comments to be blocked, and enabling tracking of comments and ideas relevant to R&D projects and identification of respective origins of those comments and ideas.

In an example embodiment, site visitors give an indication as to how much they are willing to contribute to an R&D project, for example, posting pledges 54. The pledges are an indication which does not commit the site visitor to actually providing the pledge amount. The system posts “pledge” meter on the network indicating sum 56, showing how close the R&D project is to receiving pledges for the requested amount of funding. The R&D project is shortlisted if the indication of fund contribution has met the project budget. The R&D project applicant is given a specified period of time to revise the proposal and submit it for request for contributions 57.

In an example embodiment, the R&D project applicant uploads the revised proposal to the network and request 57 is posted. The R&D project is given a predetermined time period in which to receive contributions. Site visitors/potential donors can make contributions using any means known in the art. Contributions are not executed until total contributions have reached the project budget. Once the full amount is reached, an escrow transfers the funding to the R&D project applicant's academic institution account for disbursement. The system displays the “contribution” meter to indicate the level of contribution received for the project.

The following provides further detail regarding R&D project reporting. In an example embodiment, R&D project fund recipients are assigned an electronic project log book PLB with which to communicate with donors regarding project progress. Only the R&D project fund recipients have access to make changes to the content of a PLB. The system enables the project donors to read the PLB and post comment pages. All the entries to the PLB and comments are dated and authenticated. R&D project fund recipients can upload textual reports, graphics and audio visual files to the PLB to communicate with R&D project donors. Donors can make suggestions for improvement or pose questions. The PLB is dated and authenticated, and can serve as a prior art database.

The system provides notification 74 to donors when the R&D project fund recipients upload project progress reports or findings 76 to the system. The system also can ask donors to provide ratings 78 with respect to the R&D project fund recipients and project parameters including, but not limited to ability to meet project milestones, transparency of research work, and quality of research work. The system automatically posts ratings of a funded R&D project on a fund recipient's profile page, which serves as a reference for site visitors to evaluate how worthy the R&D project fund recipient is of further support. Periodic submission of project progress reports 76 by R&D project fund recipients, for example, on an annual basis is mandatory, as is submission of a final report 80 when an R&D project is completed.

In an example embodiment, portion 20 can be applied to more than one additional R&D project. For example, rather than directing portion 20 to R&D project 18B only, the donor can direct portion 20 to two or more R&D projects from list 12. In this case, the donor selects the two or more R&D projects and selects how portion 20 is to be apportioned among the selected R&D projects.

In an example embodiment, R&D project 18A is in response to R&D project request 82 submitted by a potential donor, for example, DON, and posted on the network. For example, a potential donor posts an R&D project that the potential donor would like to see implemented, which is not currently included on list 12, and to which the potential donor is pledging financial support. Request 82 includes at least a general description of the problem the potential donor wishes to address, a request for a researcher to submit a proposed R&D project to address the problem, and a request for other potential donors to pledge financial support. In an example embodiment, system 1 receives R&D project 18A in response to request 82 and the discussion above and below regarding R&D project 18A is applicable. For example, the submitted R&D project must have a degree of novelty 38 greater than degree of novelty 40 and the discussion of funding 22 and 28, proceeds 24, portion 20, and acceptance 26 is applicable. In an example embodiment, system 1 receives replies from potential donors prior to the posting of R&D project 18A in response to request 82. System 1 stores these replies and notifies the potential donors when R&D project 18A is posted in response to request 82.

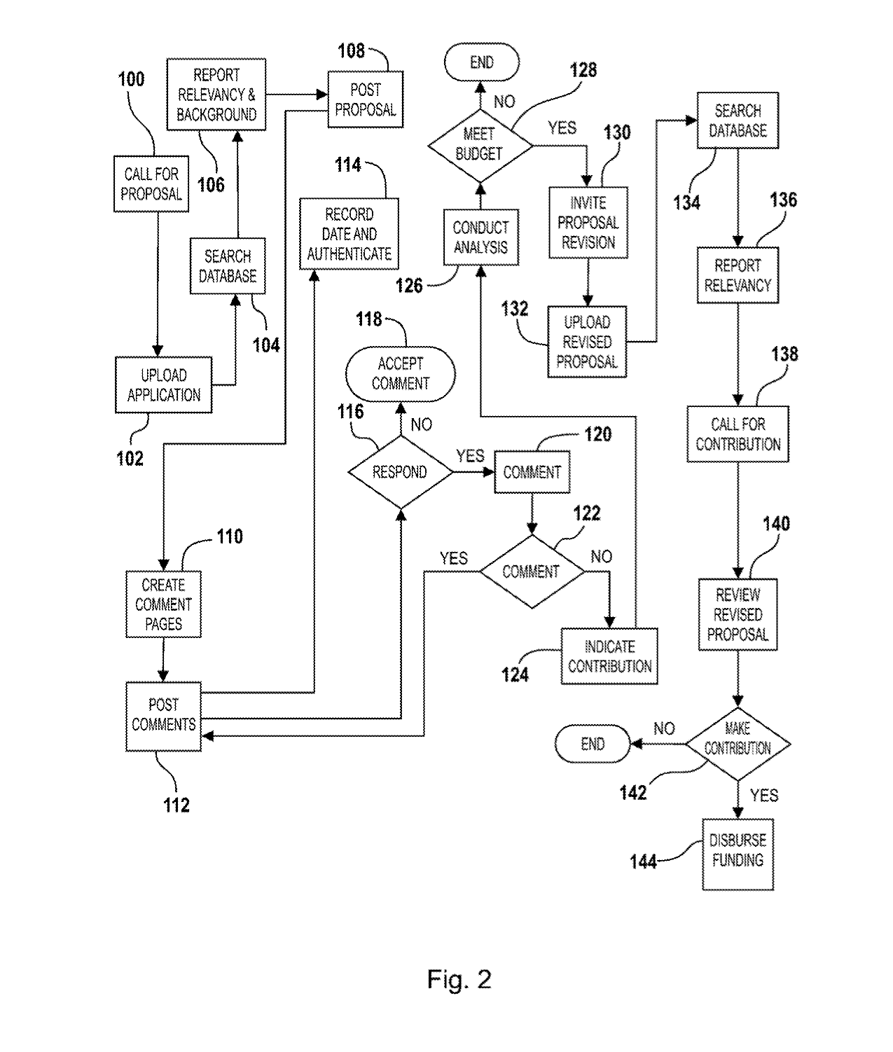

FIG. 2 is a flow chart illustrating project selection for a computer-based system for financing a research and development (R&D) related activity or project. The following should be viewed in light of FIGS. 1 and 2. Step 100 is a call for proposal of an R&D project, for example, system 1 transmits call 66 to potential R&D project contributors. Step 102 uploads candidate R&D projects, for example, list 34, to the system. In an example embodiment, the submitter of the candidate R&D project performs a novelty analysis as noted above. In Step 104, the system assesses degree of novelty 38 as noted above. Step 106 posts the results of the novelty assessment on the network. Step 108 posts proposals including degree of novelty 38 on the network, for example, posting list 12, request 14, and offer 16 on network 10.

At this point, potential donors become involved in the system. Step 110 creates comment page 72 by which site visitors can comment on R&D projects on list 12. Step 112 posts comments 58 on the network. Step 114 authenticates the comments and step 116 enables interaction regarding the comments. Step 118 refuses the comments, for example, a researcher associated with R&D project 18A can determine that the comment is not relevant or can refute the comment. This action by the researcher is available for potential donors to view. Step 120 enables reply 59 to the comment, for example, by RES via the network, and step 122 enables further communication from a potential donor, for example, via the network.

Step 124, receives pledge 54. Step 126 analyzes pledges with respect to the requested funding for R&D project 18A. Step 128 determines if sum 56 is equal to the requested/required funding for R&D project 18A. If the sum is sufficient, step 130 posts invitation 68 for another round of comments and step 132 uploads description 19 updated to include comments received from potential donors. Step 134 determines degree of novelty 60 of the updated description and step 136 posts the degree of novelty on the network. Step 138 posts a request 57 for actual contributions. Step 140 enables potential donors to view the updated description and step 142 accepts contributions. Step 144 disburses funding 22.

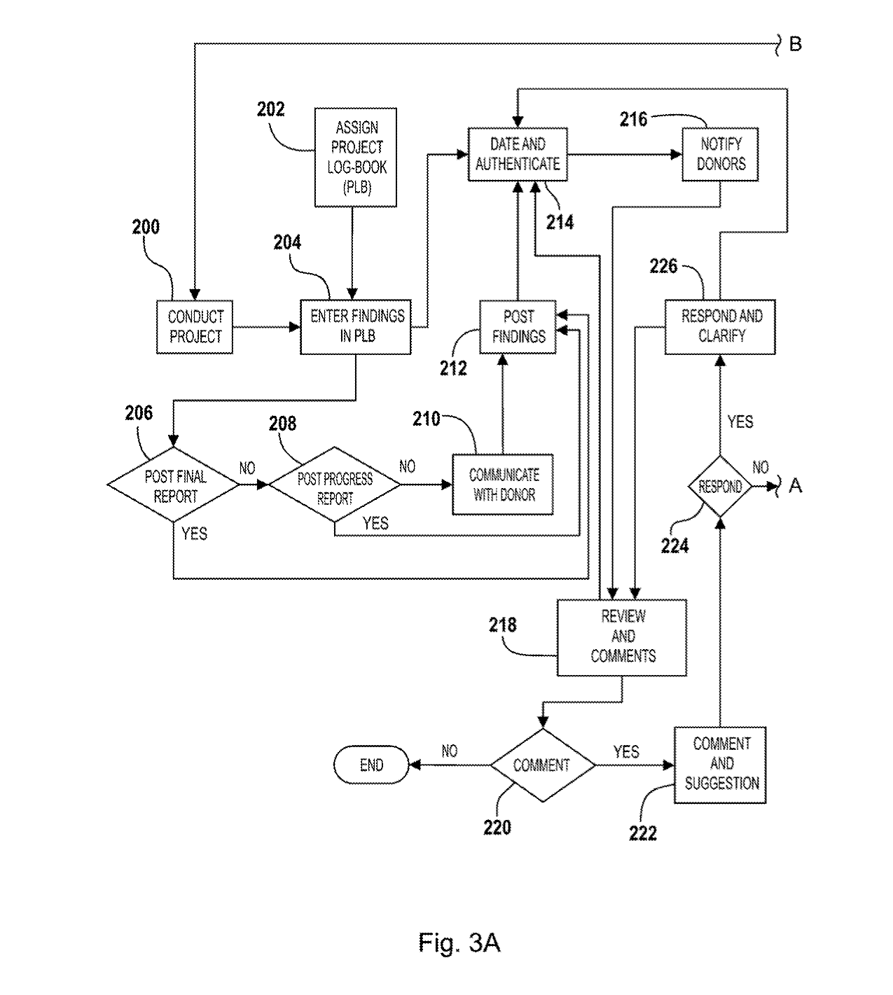

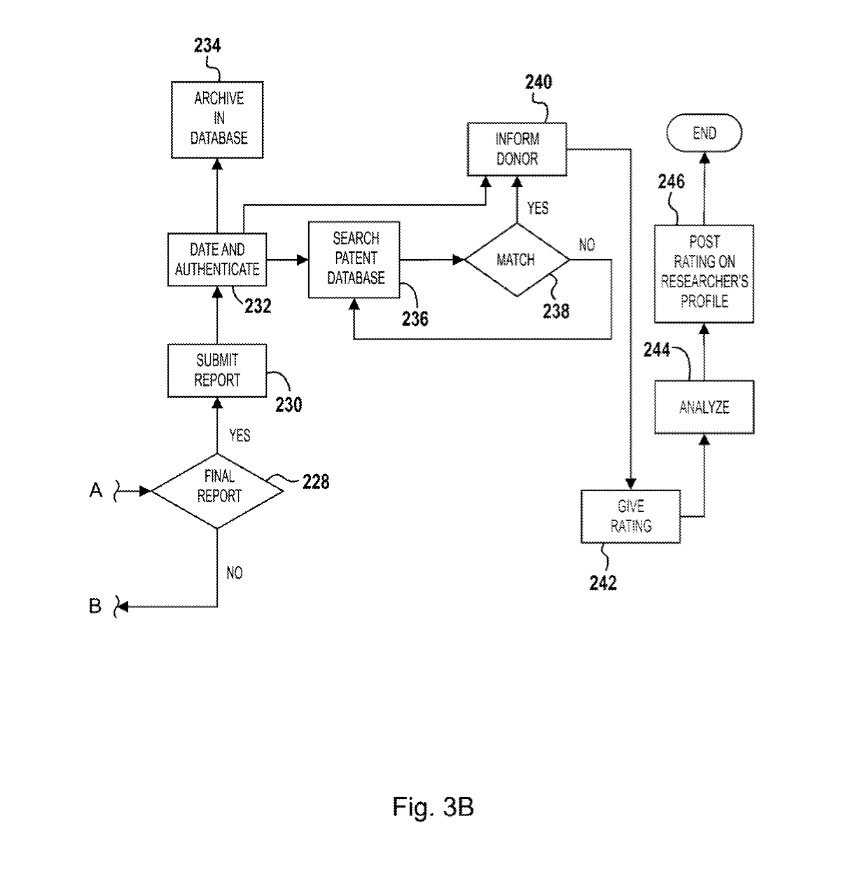

FIGS. 3A and 3B are a flow chart illustrating project reporting for a computer-based system for financing a research and development (R&D) related activity or project. The following should be viewed in light of FIGS. 1 through 3. In step 200, R&D project 18A is implemented. Step 202 generates and posts the PLB. Step 204 enters ongoing results and findings, such as reports 76 regarding the funded R&D project into the system. Steps 206 through 212 are for a cycle of posting reports and communicating with donors. Step 214 dates and authenticates PLB entries and posted findings. Step 216 notifies donors regarding posted findings. Steps 218 through 226 are for a cycle of receiving donor comments and posting responses by R&D project fund recipients. Steps 228 through 234 are for finalizing, submitting, authenticating and archiving a report. Steps 236 and 238 search for matches of a funded R&D project with patent applications and notifies donors accordingly. Step 240 informs donors, for example, regarding matches found in Step 238. Step 242 enables donors to submit ratings and comments on the performance of researchers. Step 244 calculates the overall rating of funded researchers. Step 246 posts ratings, for example, on the researcher's profile page.

Advantageously, system 1 provides a mechanism and method to successfully address the problems noted above regarding funding, control of, and veracity of R&D projects. For example, system 1 links individuals to researchers in a manner not possible prior to system 1 and infuses the university and public sector research community with funding previously not available to that community. This funding stream enables R&D projects directed to more innovative and high-impact work for the benefit of society that would otherwise fall outside of the mainstream funding process. For example, projects that may be overlooked by entrenched peer reviews or established institutions, that do not fall in the academic or corporate main stream, or that do not align with institutional thinking (academic, public sector, or private sector) are fundable via system 1. As noted above, some 95% of the world's research funding is allocated by peer reviews, and system 1 enables a process of circumventing the biases of this funding process to channel funding to more innovative R&D activity.

As noted above, the Begley article in the Huffington Post points out the problem of accuracy in reported scientific studies. The transparency and multiple review and comment cycles of system 1 provide scrutiny that can quickly detect and correct errors in funded R&D projects. As documented by the Begley article, the existing process for funding and reporting scientific studies is clearly deficient and system 1 provides a clear means of correcting these deficiencies in a novel manner not presently available.

Advantageously, system 1 further provides a means by which an average donor to an R&D project can direct the use of their contribution, creating an incentive for such a donor to become more deeply involved, in particular, financially, with the project. This incentive helps create a sustained cycle of funding for R&D projects.

Further, the ability to direct a portion of the proceeds from a first R&D project to a second R&D project creates a sense of ownership and control for donors with respect to the R&D projects and gives potential donors even further incentive for investing in the first R&D project. This ability to direct proceeds further fuels donor interest and strengthens the cycle of funding for R&D projects by individual donors.

Thus, system 1 harnesses social efforts to advance social, humanitarian, economic, politics, scientific, and technological research and development that contribute to understanding and solving environmental, health, scientific, technological, political and socio-economic challenges.

Thus, it is seen that the objects of the invention are efficiently obtained, although changes and modifications to the invention should be readily apparent to those having ordinary skill in the art, without departing from the spirit or scope of the invention as claimed. It is clear that variations to the above descriptions can be made without departing from the scope or spirit of the invention as claimed.

What is claimed is:

1. A computer-based method for financing a research and development (R&D) related activity, comprising:
storing, in at least one memory element of at least one computer, computer readable instructions; and,
executing, using at least one processor for the at least one computer, the computer readable instructions to:
transmit, for display on a publicly accessible network:
a first list including a first plurality of R&D related projects or activities and respective descriptions and estimated funding requirements for each R&D related project or activity on the first list;
a request for funding of a first R&D related project or activity from the first plurality of R&D related projects or activities; and,
an offer to provide a portion, proportional to a monetary contribution provided for the first R&D related project or activity, of proceeds generated by the first R&D related project or activity as funding for a second R&D related project or activity to be selected by a donor providing the monetary contribution for the first R&D related project or activity;
receive, from the donor: the monetary contribution and a selection of the second R&D related project or activity from the first plurality of R&D related projects or activities;
determine the proceeds generated by the first R&D related project or activity;
determine the portion of the proceeds; and,
direct a transfer of funds equal to the portion of the proceeds as funding for the second R&D related project or activity.

2. The computer-based method of claim 1, wherein each R&D related project or activity on the first list must be submitted by at least one respective university faculty member or public sector researcher for respective research and development to be conducted by the at least one respective university faculty member or researcher.

3. The computer-based method of claim 2 further comprising executing, using the at least one processor, the computer readable instructions to:
determine that the at least one university faculty member or researcher has authored a publication regarding the first R&D related project or activity; and,
transmit a notification to the entity regarding the publication.

4. The computer-based method of claim 1, further comprising executing, using at least one processor for the at least one computer, the computer readable instructions to:
receive a second list including a second plurality of R&D related projects or activities;
determine a respective degree of novelty for each R&D related project or activity in the second plurality of R&D related projects or activities with respect to information publicly available at the time at which the second list is received;
include in the first list, said each R&D related project or activity with a respective degree of novelty greater than a specified degree of novelty; and
transmit for display on the publicly accessible network, the respective degree of novelty for each R&D related project included on the first list.

5. The computer-based method of claim 1, further comprising executing, using at least one processor for the at least one computer, the computer readable instructions to:
accept respective donor registration information regarding a plurality of potential donors, the respective donor registration information including respective interests of potential donors in the plurality of potential donors;
determine a respective correlation of each R&D related project or activity on the first list with the respective interests; and,
for each R&D related project or activity on the first list with a correlation greater than a specified degree of correlation with a respective interest, transmit a respective notification regarding said each R&D related project to a potential donor having the respective interest.

6. The computer-based method of claim 1, further comprising executing, using at least one processor for the at least one computer, the computer readable instructions to:
accept respective pledges for funding the first R&D related project or activity; and,
transmit for display on the publicly accessible network, a cumulative sum of the respective pledges, wherein transmitting a request for funding of the first R&D related project or activity includes transmitting the request when the cumulative sum reaches an estimated cost for completing the first R&D related project or activity.

7. The computer-based method of claim 1, further comprising executing, using at least one processor for the at least one computer, the computer readable instructions to:
receive a comment or suggestion from the donor regarding the first R&D related project or activity;
digitally notarize the comment or suggestion to establish a time at which the comment or suggestion is received; and,
store, in the memory element, the digitally notarized comment or suggestion.

8. The computer-based method of claim 7 further comprising executing, using the at least one processor, the computer readable instructions to:
determine a degree of novelty of the first R&D related project or activity, updated to incorporate the comment or suggestion, with respect to information publicly available at the time at which the first R&D related project or activity is updated; and,
when the degree of novelty is greater than a specified degree of novelty, transmit, for display on a publicly accessible network:
a description of the first R&D related project or activity updated to incorporate the comment or suggestion; and,
the degree of novelty.

9. The computer-based method of claim 1 further comprising executing, using the at least one processor, the computer readable instructions to:
determine if a patent application based on the first R&D related project or activity has been filed; and,
transmit a notification to the entity regarding the patent application.

10. A computer-based system for financing a research and development (R&D) related activity, comprising:
at least one memory element of at least one computer configured to store computer readable instructions; and,
at least one processor for the at least one computer configured to execute the computer readable instructions to:
transmit, for display on a publicly accessible network:
a first list including a first plurality of R&D related projects or activities and respective descriptions and estimated funding requirements for each R&D related project or activity on the first list;
a request for funding of a first R&D related project or activity from the first plurality of R&D related projects or activities; and,
an offer to provide a portion, proportional to a monetary contribution provided for the first R&D related project or activity, of proceeds generated by the first R&D related project or activity as funding for a second R&D related project or activity to be selected by a donor providing the monetary contribution for the first R&D related project or activity;
receive, from the donor: the monetary contribution and a selection of the second R&D related project or activity from the first plurality of R&D related projects or activities;
determine the proceeds generated by the first R&D related project or activity;
determine the portion of the proceeds; and,
direct a transfer of funds equal to the portion of the proceeds as funding for the second R&D related project or activity.

11. The computer-based system of claim 10, wherein each R&D related project or activity on the first list must be submitted by at least one respective university faculty member or public sector researcher for respective research and development to be conducted by the at least one respective university faculty member or researcher.

12. The computer-based system of claim 10 wherein the at least one processor is configured to execute the computer readable instructions to:
determine that the at least one university faculty member or researcher has authored a publication regarding the first R&D related project or activity; and,
transmit a notification to the entity regarding the publication.

13. The computer-based system of claim 10 wherein the at least one processor is configured to execute the computer readable instructions to:
receive a second list including a second plurality of R&D related projects or activities;
determine a respective degree of novelty for each R&D related project or activity in the second plurality of R&D related projects or activities with respect to information publicly available at the time at which the second list is received;
include in the first list, said each R&D related project or activity with a respective degree of novelty greater than a specified degree of novelty; and
transmit for display on the publicly accessible network, the respective degree of novelty for each R&D related project included on the first list.

14. The computer-based system of claim 10 wherein the at least one processor is configured to execute the computer readable instructions to:
accept respective donor registration information regarding a plurality of potential donors, the respective donor registration information including respective interests for potential donors in the plurality of potential donors;
determine a respective correlation of each R&D related project or activity on the first list with the respective interests; and,
for each R&D related project or activity on the first list with a correlation greater than a specified degree of correlation with a respective interest, transmit a respective notification regarding said each R&D related project to a potential donor having the respective interest

15. The computer-based system of claim 10 wherein the at least one processor is configured to execute the computer readable instructions to:
accept respective pledges for funding the first R&D related project or activity; and,
transmit for display on the publicly accessible network, a cumulative sum of the respective pledges, wherein transmitting a request for funding of the first R&D related project or activity includes transmitting the request when the cumulative sum reaches an estimated cost for completing the first R&D related project or activity.

16. The computer-based system of claim 10 wherein the at least one processor is configured to execute the computer readable instructions to:
receive a comment or suggestion from the donor regarding the first R&D related project or activity;
digitally notarize the comment or suggestion to establish a time at which the comment or suggestion is received; and,
store, in the memory element, the digitally notarized comment or suggestion.

17. The computer-based system of claim 16 wherein the at least one processor is configured to execute the computer readable instructions to:
determine a degree of novelty of the first R&D related project or activity, updated to incorporate the comment or suggestion, with respect to information publicly available at the time at which the first R&D related project or activity is updated; and,
when the degree of novelty is greater than a specified degree of novelty, transmit, for display on a publicly accessible network:
a description of the first R&D related project or activity updated to incorporate the comment or suggestion; and,
the degree of novelty.

18. The computer-based system of claim 10 wherein the at least one processor is configured to execute the computer readable instructions to:
determine if a patent application based on the first R&D related project or activity has been filed; and,
transmit a notification to the entity regarding the patent application.

19. A computer-based method for financing a research and development (R&D) related activity, comprising:
storing, in at least one memory element of at least one computer, computer readable instructions; and,
executing, using at least one processor for the at least one computer, the computer readable instructions to:
transmit, for display on a publicly accessible network:
a first list including a first plurality of R&D related projects or activities and respective descriptions and estimated funding requirements for each R&D related project or activity on the first list;
a request for funding of a first R&D related project or activity from the first plurality of R&D related projects or activities; and,
an offer to provide a portion, proportional to a monetary contribution provided for the first R&D related project or activity, of proceeds generated by the first R&D related project or activity as funding for a second R&D related project or activity to be selected by a donor providing the monetary contribution for the first R&D related project or activity;
accept respective donor registration information regarding a plurality of potential donors, the respective donor registration information including respective interests for potential donors in the plurality of potential donors;
determine a respective correlation of each R&D related project or activity on the first list with the respective interests;
for each R&D related project or activity on the first list with a correlation greater than a specified degree of correlation with a respective interest, transmit a respective notification regarding said each R&D related project to a potential donor having the respective interest;
receive, from the donor: the monetary contribution and a selection of the second R&D related project or activity from the first plurality of R&D related projects or activities;
determine the proceeds generated by the first R&D related project or activity;
determine the portion of the proceeds; and,
direct a transfer of funds equal to the portion of the proceeds as funding for the second R&D related project or activity.
